(19) United States
(12) Patent Application Publication
(10) Pub. No.: US 2004/0116940 A1
(43) Pub. Date: Jun. 17, 2004

(54) Device for marking livestock and simultaneously taking tissue samples

(76) Inventor: Gottfried Brem, Hilgenshausen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/643,380

(22) Filed: Aug. 19, 2003

Related U.S. Application Data
(63) Continuation of application No. PCT/EP02/01859, filed on Feb. 21, 2002.

(30) Foreign Application Priority Data
Feb. 21, 2001 (EP) 01 104 188.6

(51) Int. Cl. A61D 1/04

(52) U.S. Cl. 606/117

(57) ABSTRACT

The invention relates to a device for marking animals and simultaneously taking samples. The present invention especially relates to a device by which means such steps can be simultaneously carried out, using conventional earmarks.

### RELATED APPLICATIONS

This application is a continuation and claims the benefit of priority of International Application No. PCT/EP02/01859 filed Feb. 21, 2002, designating the United States of America and published in German as WO 02/065832, which claims the benefit of priority of European Application No. 01 104 188.6 filed Feb. 21, 2001, both of which are hereby expressly incorporated by reference in their entireties.

### FIELD OF THE INVENTION

The present invention relates to a device for marking animals and simultaneously taking samples. In particular, the present invention relates to a device with which such method steps can be simultaneously carried out using conventional earmarks.

### BACKGROUND OF THE INVENTION

Due to the diseases in livestock/useful animals which pertain in Europe, such as Bovine Spongiform Encephalopathy (BSE), it is desirable on the part of both manufacturers and consumers to be able to provide and obtain respectively information about the origin and, if applicable, the genetic composition of the animals. This should, on the one hand, provide reliable assurance about identity and origin, and, on the other, as well as other veterinary applications, make possible an analysis of the DNA for particular resistance or predisposition of these animals in respect of these diseases.

To this end, on the one hand the animals must be provided with a means of identification, such as is in principle specified by national authorities, and a sample taken from the animals, on the basis of which the animals can be genotypically examined. There are a large number of reasons for the taking of tissue samples, such as:

to store these samples and deposit them in a tissue bank, or

to isolate DNA from these tissue samples, and store it, or

to analyze the isolated DNA's immediately and to genotype the animals and collect

the data in a databank, or

to carry out a combination of these procedures (e.g. genotyping and additional storage of DNA for later extensive research).

At the present time, the problem arises of taking tissue samples from animals which are not intended, or no longer intended, for human consumption, but which are, for example, to be destroyed in the interests of cleansing the market. In this context it is of importance that tissue samples be taken from these bovines, in order that these, or the DNA later isolated from them, are available for scientific examination within the framework of BSE research.

In WO 98/03075 a method is disclosed for the identification marking and simultaneous obtaining of tissue samples. In this situation, a tissue sample is punched out with the hollow tip of an ear mark specially designed for this purpose when the ear is pierced in order to set the mark in place, this sample then being placed directly in a sample collection container, and dried out by the highly hygroscopic molecular sieve located therein, in such a way that it can be stored for years before the isolation of the DNA.

Among users, however, there is a requirement to continue working with convention earmarks, since these represent a technique of animal identification which has been tried and trusted for many years, and enjoys the trust of professional associations and animal owners. Thus, in particular “in the field” the serviceability (>10 years) of the plastics has been proved, under adverse environmental conditions, with the script remaining legible, and most of these ear marks are, in addition, “closed”; i.e. the tip of the spur is entirely surrounded by a cap, so that it is protected against manipulation. A further consideration is that the ear marks are available very economically, since they are manufactured per year worldwide using well-established and readily available production systems, in numbers of hundreds of millions. Use of existing ear marks also has the advantage that no new approval or recognition procedures are required for the ear marks.

One problem therefore lies in providing a simple and rapid marking of useful animals with simultaneous taking of tissue samples, whereby the ear marks presently used can be employed.

### SUMMARY OF THE INVENTION

This problem is resolved in the present invention by a device for the simultaneous introduction of an ear mark and the removal of a tissue sample, which exhibits a first device for accommodating a female (hole) plate and a second device, arranged essentially in the vicinity of the first device, for accommodating a sample container, as well as a third device, located essentially opposite the first device, for accommodating a male (spur) plate, and a fourth device, located essentially opposite the second device, for accommodating sample obtaining means, means for bringing together the devices essentially opposite one another in each case, whereby, when the first, second, and third or fourth devices respectively are brought together, the ear mark is secured to the animal, and at the same time the means for obtaining the sample, conveying the sample with it, is guided through the ear of the animal into the sample container, and closes this in a sealing manner.

### BRIEF DESCRIPTION OF THE DRAWINGS

FIG. 1A is a side view of a preferred embodiment of the invention, in which a conventional set of tongs, shown in diagrammatic form, for the introduction of ear marks, exhibits two pins and two accommodation devices for accommodating an ear mark and a specimen container.

FIG. 1B is a view from above of the hole plate of the ear mark and the sample container arranged next to it, as they are arranged in the device according to FIG. 1A.

FIG. 2A is a view from the front of a further preferred embodiment of the invention, in which the accommodation devices and pins are arranged in each case next to one another on jaws of a set of tongs.

FIG. 2B is a view of a hole plate and of the sample container from above, as they are arranged in the device according to FIG. 2A.

FIGS. 3A-D show sample container from different views, with different covers in each case.

### DETAILED DESCRIPTION OF THE PREFERRED EMBODIMENT

According to a preferred embodiment, the device according to the invention exhibits the shape of a pair of tongs, and for greater preference the shape of a conventional ear marking tongs, such as are used at present for the introduction of ear marks. These ear marking tongs have now been modified in such a way that they exhibit a further accommodation device for the sample container in the vicinity of the accommodation device for the hole plate, as well as a further pin, which is essentially located opposite the further accommodation device for the sample container, so that, when the pin carrying the sample obtaining means is crimped together, the said means are conducted through the tissue of the animal, carrying a biological sample with it into the sample container.

The means for obtaining the sample are designed in such a way that they are shaped at their front end such that a sample of the tissue can be obtained, such as, for example, by punching or cutting or piercing. The rear end of the means for obtaining the sample is further designed in such a way that it, in its turn, fits into the device in the tongs, and, further, when introduced into the sample container, closes this in a sealing manner. The sample container can take any form, provided that it is matched to the corresponding device for accommodating the sample container. For preference the sample container exhibits a tongue, on which a corresponding marking can be applied or can already be provided for.

The device for accommodating the sample container can, by analogy to the device for accommodating a hole plate, be a depression, into which the sample container is introduced, and remains there in a stable manner. In this situation, the lateral height of the devices for accommodating the hole plate and for accommodating the sample container is selected in such a way that, simultaneously with the closure of the ear mark, the sample container with the means for obtaining the sample are also closed.

With the devices according to the invention, tissue samples can in principle be taken “in front of” or “next to” the axis of the spur of a conventional ear mark, or also at other places, whereby the designations “in front of” and “next to” are to be regarded in each case in relation to the means for bringing together the individual devices, i.e. to the hand part of the tongs or the point of rotation respectively.

For the taking of a tissue sample, which is to occur simultaneously with the application of an ear marking, “in front of” the ear mark, the tongs must exhibit both a second, for preference metallic, inner spur, as well as a second accommodation point for the body of the sample collection container, for preference cylindrical/truncated conical in shape. Both additional devices are in this case located in positions lying in the direction of the point of rotation of the tongs, i.e. behind the original devices positioned at the tip of the tongs for accommodating the conventional ear mark parts. In addition to this, a retention device can be located on the tongs for the tongue of the sample collection container, which is designed, for example, as a carabineer hook and in which the hole aperture of the tongue is located, so that, when the tongs are removed from the ear of the animal, the tongue fixed to the tongs above the hole aperture holds the collection container securely.

According to a further embodiment according to the invention, a tissue sample can also be taken “behind” the ear mark, i.e. in the longitudinal extension of the limbs of the tongs, if the ear mark is rotated through at least 90° when it is introduced.

A sample can be taken next to the axis of the spur of the conventional ear mark, for example, by designing the ear mark part of the tongs as being with double limbs. It is clear to the person skilled in the art, however, that tongs can also be used with which the arrangement is effected “next to one another” on one limb.

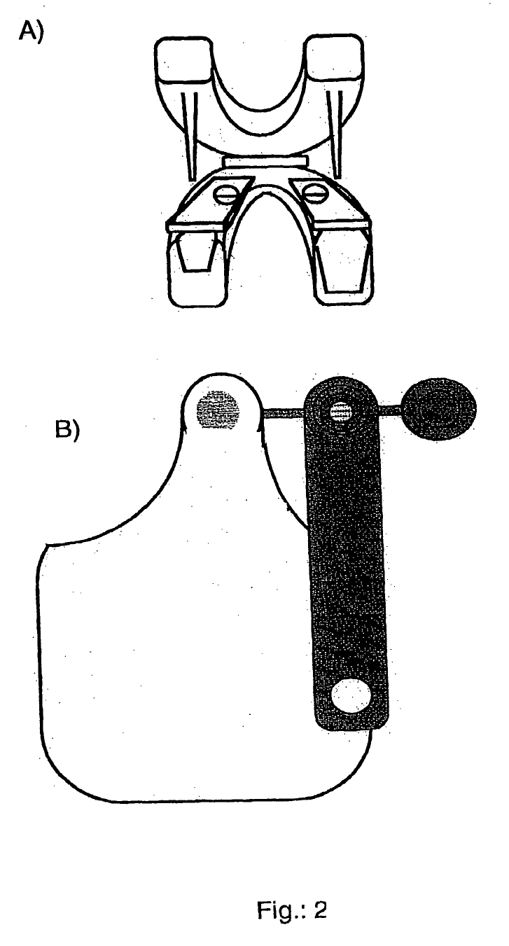

With the two-limbed embodiment, in each case one limb of the tongs is located in the conventional manner on one side at an essentially equal distance from the middle axis of the tongs, in order to carry the ear mark. The limb on the other side carries an accommodation device for the sample collection container and a retention device for the tongue of the sample collection container. The tongs accordingly likewise have a double limb (FIG. 2A) for accommodating the spur part of the conventional ear mark and the tissue sampling tip required for stamping out the tissue (e.g., a hollow tip, which is in the shape of a truncated cone, for example, and has for preference a metallic sleeve with a sharp edge, which penetrates the ear and in the process stamps out the tissue sample without leaving any parts behind in the ear).

By contrast with a conventional sampling procedure, i.e. the taking of a tissue sample without combining the introduction of ear marks with the advantages referred to in terms of identification and conservation, the parallel taking of samples simultaneously with the introduction of the ear mark in front of or next to the axis of the spur achieves a clear saving of labour and a massive reduction in the error quota.

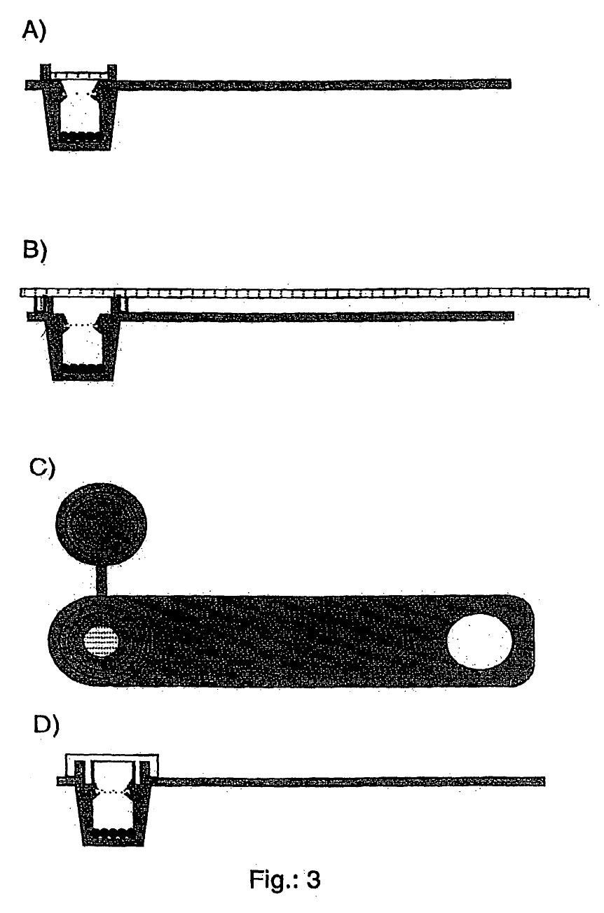

The sample collection container can contain preservation means for the biological sample, such as molecular sieves, for example, which will prevent the destruction/lysis of the tissue and the DNA. This molecular sieve can be introduced loose into the sample collection container, or be fixed to the base of the sample collection container by heat processes or by adhesive bonding (FIGS. 3A, B and D).

The sample collection container can, in addition, be designed in such a way that it already represents a closed container before use, which exhibits one or more covers, and with which the penetration of the sampling means causes the cover to be pierced, but this immediately recloses automatically (FIGS. 3A and B).

Immediately after the obtaining of the sample, under normal circumstances the sample chamber surrounds the sample obtaining means and the sample in an airtight manner. As additional security and for the later processing of the tissue samples, it is possible, during the manufacture of the sample collection container, for a cover made of plastic to be manufactured simultaneously (FIG. 3C), which, after the obtaining of the sample and the removal of the sample collection container, is plugged/pushed out of the tongs onto the upper end of the sample collection container and seals it in an airtight manner, in that the web of the collection container is securely surrounded inside and outside by webs of the cover (FIG. 3D). This represents an additional security for the airtight preservation of the sample.

To improve the stamping action, it is possible for either a ring-shaped part of the part surrounding the spur to be laid into the upper aperture of the sample collection chamber, or simply a disk made of suitable plastic (FIG. 3A). The result of this is that the tip of the means for obtaining the sample come in contact with a suitable counter-piece when the tongs are closed, and a piece of tissue will therefore be reliably stamped out, even if the ear tissue is extremely soft and offers little resistance, as is the case, for example, with newly-born lambs or piglets. Without this “bearing surface”, in many cases no adequate samples could be stamped out/obtained, because the tissue would tear and the stamping process would be deflected before sufficient material had been taken up in the hollow tip of the sampling means.

The present invention also relates to a method for the marking of useful animals and the simultaneous taking of samples, in which a device according to the invention is used.

In this situation, parts of the conventional ear marks and the sample containers and sample obtaining means respectively are loaded separately into the tongs, before, by pressing them together on the ear of the animal, the ear mark is applied and the sample obtaining means are passed simultaneously through the ear of the animal into the sample container.

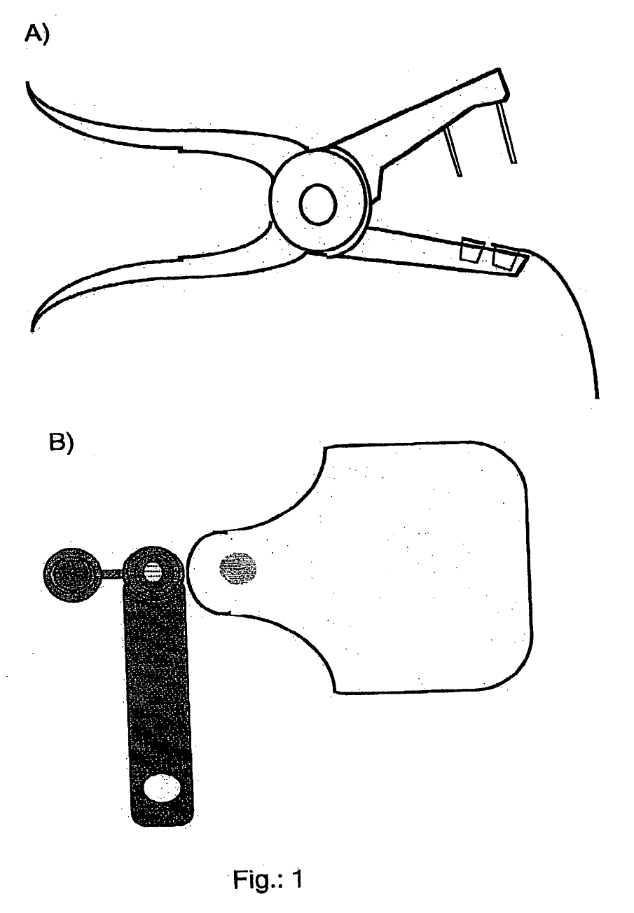

As an alternative embodiment, however, in order to simplify the process, sample obtaining means and sample container can be connected to the corresponding parts of the ear mark (see FIGS. 1B and 2B), so that the loading of the tongs is simplified. The fixing/connection can be effected, for example, by ultrasonic welding, adhesive bonding, or any other form of connection or assembly which is suitable for connecting the two parts in such a way that remain next to one another for use and can be easily separated from one another after use, in that the sample collection container is torn off or remains in the tongs respectively when the ear mark has been introduced onto the animal.

An important point with the proposed method is the writing on the sample container. If the sample container and ear mark carry different numbers, these numbers must be linked with the aid of lists or electronically, which has the disadvantage that additional work involvement and potential sources of error are incurred. According to a preferred embodiment, the sample collection container is therefore provided with the same number as the ear mark bears. This can be achieved in a variety of ways. Most simply, ear mark and collection container are marked in one operation, e.g. by laser marking, and the numbers and barcode and/or matrix code are applied simultaneously to all parts. If the ear marks are already marked, the number or the code respectively are identified by a reader device and then copied onto the collection container.

For the storage of the sample collection containers for periods of years, it is to advantage for them to be arranged after collection in groups of 100 or 1,000 units or in accordance with specific criteria and welded under vacuum into plastic bags. This allows it to be ensured that no negative influences can take effect on the sample container during storage, such as water, damp, dirt, or dust, even if, in individual cases, it is not intended that the tightness of individual sample collection containers is to be permanently guaranteed. This form of sample storage is very space-saving and economical: For a million samples, a space of less than some 5 m³ is required, whereby this space is not required to fulfil any particular conditions with regard to light conditions or dryness/moistness.

The taking of tissue samples from useful animals in parallel with the introduction of ear marks can also be used in order to take more than just one sample (up to 4) from an animal simultaneously with the placement of the ear mark. This allows, for example, for DNA to be isolated immediately and analyzed, and the second sample to be stored and kept as a restoration sample for various purposes.

In the European Community, the identification marking of bovines with two ear marks is a regulatory requirement (see Directive for protection against the spreading of animal diseases in commercial trafficking of animals—Animal Trafficking Directive). If the taking of samples is effected in parallel with the placement of the ear marks, it is sufficient if a sample is removed when one of the marks is introduced. If in a population in which all animals are typed, at the replacement of ear marks which have been lost or fallen out, in all cases a tissue sample is taken in parallel with the placement of the ear mark, then it is possible to determine by genotyping whether the replacement ear mark has indeed be placed on the animal on which the ear mark has been reported lost.

To obtain more than just one sample, the device according to the invention can now also be used for a sample to be obtained from both ears of a useful animal. This allows, for example, for DNA to be isolated and analyzed from a sample immediately, and the second sample to be stored and retained as a restoration sample for various purposes. If it is intended that more than just two samples are to be taken, then the Typi-Fix® ear marks, which are commercially available (see WO 98/03075, which is hereby incorporated by reference to the Description of the design features of the Typi-Fix® ear marks), are used, with which a simultaneous sampling and marking of the animal at one place is rendered possible (at the point of the ear mark). In this case, therefore, during the marking of the animal on one ear two samples can be taken, one with the aid of the Typi-Fix® ear mark, and one with the aid of the separate sample collection container and sample collection means, in front of or next to the Typi-Fix® ear mark.

An advantage in this situation is also the fact that the sample which was acquired by means of a Typi-Fix® ear mark does not need to be collected immediately, but can remain on the animal. In these cases, it can be of advantage for the tongue of the Typi-Fit® ear mark to be somewhat shortened, and for the hole at the end of the tongue to be done away with. It is then possible for the sample collection container, connected to the female part of the ear mark, with the sample packed in it, to remain on the ear mark and therefore on the animal. At a later point in time, if a further DNA identification of the animal is desired, the sample collection container, which naturally is likewise provided with the identity of the animal and the ear mark number of the animal respectively, can be collected and analyzed.

This may be required in particular if the animal is, for example, exported out of the EU. Another possibility is that this identified sample is routinely collected and analyzed when the animal is slaughtered. Another use can consist of this preserved sample being removed from the ear mark and fixed to the carcass, and accompanying it to butchery, during possible deep-frozen storage, or on long-distance transport from South America to Europe, or being used during the BSE test as control tissue for securing the identity and origin of the brain sample.

Instead of a simple sample collection container, it is also possible for what is referred to as a mini-flag to be used, in order to be able to determine at a later date that a sample has been taken from the animal. In this situation, a Typi-Fix® ear mark on a smaller scale is placed next to a conventional ear mark, so that, in addition to the ear mark, the mini-flag remains in place and indicates that a biological sample has already been taken from this animal.

The invention is explained in greater detail on the basis of the following examples.

### EXAMPLE 1

A set of tongs from Messrs. Merko of Belgium was converted by the provision of a second accommodation mounting and a second metal spur. Ear marks from Messrs. Allflex were adhesively bonded to sample collection containers of the Typi-Fix® system in such a way that the sample collection container came to be located in front of the ear mark. The numbers present on the conventional ear marks were read off and applied to the sample collection container.

With fifty samples taken from the ears of cattle (converted tongs from Messrs. Merko, ear mark with subsequently-applied text from Messrs. Allflex, Typi-Fix® collection container with stamped cover and molecular sieve welded in), it was possible in all cases for a tissue sample to be obtained simultaneously with the placing of the ear mark. After two months storage, DNA was isolated from the tissue samples in the Typi-Fix® sample collection containers with the aid of isolation kits from Machery & Nagel. On average, 30 μg of DNA was isolated. In all cases it was possible during the subsequent micro-satellite analysis for the animals to be unambiguously genotyped.

Ear marks from Messrs. Caisley were connected to sample collection containers by ultrasonic welding in such a way that the sample collection container came to be located next to the spur axis of the conventional ear mark. Ear marks and collection containers were simultaneously provided with identical numbers. By connecting the front parts of the limbs of the two tongs from Messrs. Hauptner, a set of tongs was formed with which, in addition to the ear mark, a sample could also be taken.

From all twenty of the samples taken from lambs in the first week of life (converted tongs from Messrs. Hauptner, newly labelled ear mark from Messrs. Caisley, Typi-Fix® collection container with stamped cover inserted and molecular sieve welded in), DNA (on average 20 μg of DNA) was isolated and genotyped.

What is claimed is:

1. A device for the simultaneous placing of ear marks and taking of a tissue sample, comprising:
a first device for accommodating a hole plate,
a second device arranged essentially in the vicinity of the first device, for accommodating a sample container,
a third device located essentially opposite the first device, for accommodating a spur plate, and
a fourth device, located essentially opposite the second device, for accommodating sample obtaining means,
means for bringing together the devices, essentially located opposite one another,
whereby, when the first, the second, and the third or the fourth devices respectively are brought together, the ear mark is secured to the animal, and simultaneously the sample obtaining means, carrying the tissue with them, are passed through the ear of the animal into the sample container, and close the container with a sealing effect.

2. The device of claim 1, wherein the first and the second device are depressions matched to accommodate the hole plate and the sample container respectively.

3. The device of claim 1, wherein the third and fourth devices are pins matched to accommodate the spur plate or the sample obtaining means respectively.

4. The device according of claim 1, wherein the devices for accommodating the ear mark parts and the devices for accommodating the sample container and the sample obtaining means are arranged behind one another or next to one another in relation to the bringing together of the devices.

5. A method of marking of an animal, comprising using the device of claim 1 and further comprising taking of a biological sample from said animal using the device of claim 1.

6. The method of claim 5, whereby more than one sample is taken from the animal.

7. The method of claim 6, wherein at least one sample container is taken from the animal and at least one of the remaining sample containers remains on the animal.

8. The method of claim 5, wherein said sample container is a Typi-Fix® ear mark.
